(19) United States
(12) Patent Application Publication
(10) Pub. No.: US 2025/0080828 A1
(43) Pub. Date: Mar. 6, 2025

(54) CONTROL DEVICE, CONTROL METHOD, AND STORAGE MEDIUM

(71) Applicant: CANON KABUSHIKI KAISHA, Tokyo (JP)

(72) Inventor: AKIRA HAMANO, Ibaraki (JP)

(21) Appl. No.: 18/796,673

(22) Filed: Aug. 7, 2024

(30) Foreign Application Priority Data
Aug. 30, 2023 (JP) 2023-140389

(51) Int. Cl. H04N 23/62; G06F 3/04817; G06F 3/0483; H04N 23/69; H04N 23/695

(52) U.S. Cl. CPC H04N 23/62; G06F 3/04817; G06F 3/0483; H04N 23/69; H04N 23/695

(57) ABSTRACT

A control device includes a thumbnail image acquisition order determination unit configured to determine an order of acquiring thumbnail images, which are images corresponding to presetting information including one or a plurality of set values regarding a camera, in such a manner that a thumbnail image corresponding to a presetting for which at least a set value for changing an angle of view of the camera is included, among the thumbnail images is acquired with priority, a thumbnail acquisition unit configured to acquire the thumbnail images according to the order determined by the thumbnail image acquisition order determination unit, and a thumbnail display control unit configured to display the thumbnail images on a display unit.

### BACKGROUND OF THE INVENTION

### Field of the Invention

The present invention relates to a control device, a control method, and a storage medium.

### Description of the Related Art

In recent years, pan-tilt cameras that are able to drive an imaging unit of a camera in a pan direction or a tilt direction remotely have been used at sites of video production. Out of such pan-tilt cameras, a pan-tilt camera having a presetting function of registering in advance settings regarding an angle of view such as a pan angle or a tilt angle, settings regarding zoom, and settings regarding image quality such as white balance, and reading registered contents to reflect the contents in set values is known.

In general, since multiple presettings can be registered in a camera, it is difficult for a user to identify multiple registered presettings only with registration numbers and respective set values. On the other hand, a pan-tilt camera having a function of performing presetting thumbnail display to allow a user to easily identify each presetting is known.

The presetting thumbnail display is a function of storing an image captured by the camera on registration of a presetting in the camera, acquiring the image with a control device such as WebUI or a controller application via a network, and displaying the image in the form of a thumbnail.

As described above, multiple presettings can be stored. For this reason, there is a problem in that a client apparatus needs to acquire as many thumbnail images as the number of presettings, much time is required until an actually acquired image is displayed in the form of a thumbnail, and the user is unable to quickly shift to a next operation.

According to a method described in Japanese Patent Laid-Open No. 2014-53669, in acquiring multiple thumbnail images, an order of thumbnail images to be acquired is changed according to an operation of a user. Thus, it is possible to display thumbnail images in a descending order of importance for the user.

However, this method needs an operation of the user to change the order of the thumbnail images, and much time is required until the user is able to shift to an operation to be executed after the thumbnail images have been acquired.

According to a method described in Japanese Patent Laid-Open No. 2011-4055, while an order of acquiring thumbnail images can be automatically changed according to a rule regarding a file name, a creation time, or the like, there is a problem in that it is difficult for a user who uses a presetting function to use the presetting function.

### SUMMARY OF THE INVENTION

A control device of one aspect of the present invention includes at least one processor or circuit configured to function as: a thumbnail image acquisition order determination unit configured to determine an order of acquiring thumbnail images, which are images corresponding to presetting information including one or a plurality of set values regarding a camera, in such a manner that a thumbnail image corresponding to a presetting for which at least a set value for changing an angle of view of the camera is included, among the thumbnail images is acquired with priority, a thumbnail acquisition unit configured to acquire the thumbnail images according to the order determined by the thumbnail image acquisition order determination unit, and a thumbnail display control unit configured to display the thumbnail images on a display unit.

Further features of the present invention will become apparent from the following description of embodiments with reference to the attached drawings.

### BRIEF DESCRIPTION OF THE DRAWINGS

FIG. 1 is a configuration diagram illustrating an example of an entire system.

FIG. 2 is a configuration diagram illustrating an example of an imaging apparatus.

FIG. 3 is a configuration diagram illustrating an example of a control device.

FIG. 4 is a configuration diagram illustrating an example of a program of the imaging apparatus.

FIG. 5 is a configuration diagram illustrating an example of a program of the control device.

FIG. 6 is a configuration diagram illustrating an example of a functional configuration of a presetting thumbnail image display program.

FIG. 7 is a flowchart illustrating an example of processing in a first embodiment.

FIG. 8 is a flowchart illustrating an example of processing details in the first embodiment.

FIG. 9 is a diagram illustrating an example of presetting registration information in the first embodiment.

FIG. 10 is a diagram illustrating an example of a sequence diagram between the imaging apparatus and the control device in the first embodiment.

FIGS. 11A to 11C are diagrams illustrating an example of a display unit of the control device in the first embodiment.

FIG. 12 is a flowchart illustrating an example of processing in a second embodiment.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

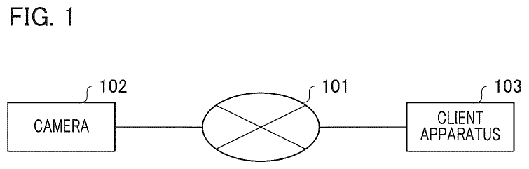

A first embodiment of a present embodiment will be described with reference to FIGS. 1 to 11. FIG. 1 is a configuration diagram illustrating an example of an entire system. The system according to the first embodiment is configured with a network 101, a camera 102, and a client apparatus 103.

The network 101 is a network that connects the camera 102 and the client apparatus 103. The network 101 is realized by, for example, a plurality of routers, switches, and cables conforming to a communication standard such as Ethernet (Registered Trademark). The network 101 may be realized by the Internet, a wired local area network (LAN), a wireless LAN, or a wide area network (WAN).

The camera 102 captures image data or video data via a lens. In the first embodiment, the camera 102 transmits captured image data or the status of the camera 102 according to a request from the client apparatus 103 via the network 101.

Note that, in other examples, the camera 102 may actively transmit image data to the client apparatus 103 connected thereto in advance. The client apparatus 103 is a transitory client terminal such as a personal computer (PC), a tablet, or a smartphone.

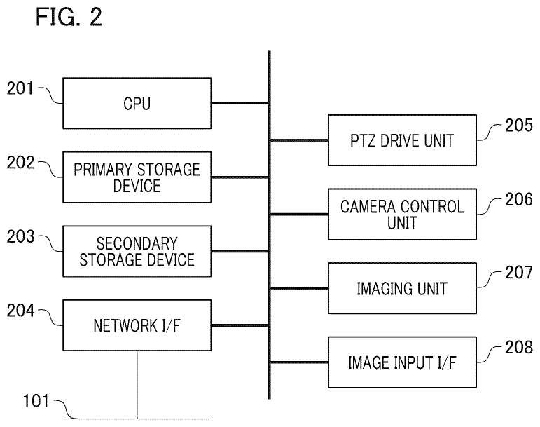

Next, a hardware configuration of the camera 102 in the first embodiment will be described with reference to FIG. 2. FIG. 2 is a configuration diagram illustrating an example of an imaging apparatus. In the first embodiment, the camera 102 includes a CPU 201, a primary storage device 202, a secondary storage device 203, and a network interface (I/F) 204.

In the first embodiment, the camera 102 includes a pan/tilt/zoom (PTZ) drive unit 205, a camera control unit 206, an imaging unit 207, and an image input interface (I/F) 208.

The operation of the camera 102 is controlled by the CPU 201 suitably executing an operating system (OS) and various programs loaded from the secondary storage device 203 into the primary storage device 202.

In the camera 102, an angle of view is determined and parameters necessary for imaging are designated by the PTZ drive unit 205 and the camera control unit 206, and an image is captured by the imaging unit 207 under the angle of view and the parameters.

In addition, image data indicating the image is input via the image input I/F 208, is stored in the primary storage device 202 or the secondary storage device 203, and is transmitted to the client apparatus 103 via the network I/F 204.

The camera 102 is able to receive control commands from the client apparatus 103 via the network I/F 204 and transfer the control commands to various programs to execute the control commands.

Here, the primary storage device 202 is also used as a work area when the OS, various programs, various kinds of data, and the like are loaded and executed by the CPU 201, and a writable high-speed storage device represented by a random access memory (RAM).

On the other hand, the secondary storage device 203 is used as a permanent storage area for the OS, various programs, various kinds of data, and the like. The secondary storage device 203 is also used as a temporary storage area for various kinds of data and the like, and is a non-volatile storage device represented by a hard disk drive (HDD) or a flash memory.

The network I/F 204 is connected to the network 101. Network communication with the client apparatus 103 is transmitted to various programs via the network I/F 204. The PTZ drive unit 205 controls a motor and the like to control the PTZ of the camera 102.

In other examples, the PTZ drive unit 205 may be a camera control unit that takes charge of not only PTZ control but also settings or control of the camera 102 such as focus and white balance. The camera control unit 206 executes control regarding imaging parameters such as white balance and focus.

The imaging unit 207 includes a lens and an imaging element, images a subject, and converts an image generated by imaging into an electrical signal. The image input I/F 208 generates image data from the electrical signal.

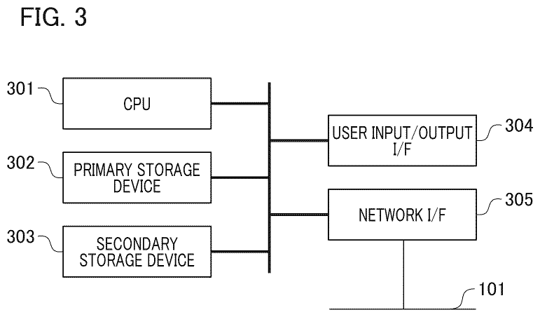

Next, a hardware configuration of the client apparatus 103 in the first embodiment will be described with reference to FIG. 3. FIG. 3 is a configuration diagram illustrating an example of a control device.

The client apparatus 103 is configured with a CPU 301, a primary storage device 302, a secondary storage device 303, a user input/output interface (I/F) 304, and a network interface (I/F) 305.

The operation of the client apparatus 103 is controlled by the CPU 301 suitably executing an OS and various programs loaded from the secondary storage device 303 into the primary storage device 302.

Specifically, the client apparatus 103 executes programs according to a user operation input via the user input/output I/F 304 and transmits control commands to the camera 102 via the network I/F 305 depending on processing contents. The user input/output I/F 304 displays results of the processing contents, video acquired from the camera 102, and the like.

Here, the primary storage device 302 is also used as a work area when the OS, various programs, various kinds of data, and the like are loaded and the CPU 301 executes the OS, various programs, and the like, and is a writable high-speed storage device represented by a RAM.

The secondary storage device 303 is used as a permanent storage area for the OS, various programs, various kinds of data, and the like, is also used as a temporary storage device for various kinds of data and the like, and is a non-volatile storage device represented by an HDD or a flash memory.

The user input/output I/F 304 is an I/F that is provided for the client apparatus 103 to receive an operation from the user. The user input/output I/F 304 is an I/F that is provided to input user information. The user input/output I/F 304 is an I/F that is provided to output video and the like to the user.

Examples of the user input/output I/F 304 include a display, a touch panel, a keyboard, a mouse, and a microphone. Here, the touch panel and the display may be configured as an integrated type such as a touch panel-mounted display where a touch position is known. These I/Fs are used for a touch operation, a mouse operation, a voice input, processing using captured images, and the like.

The network I/F 305 is an interface that is provided for connection to the network 101. Network communication from the camera 102 is transferred to various programs via the network I/F 305.

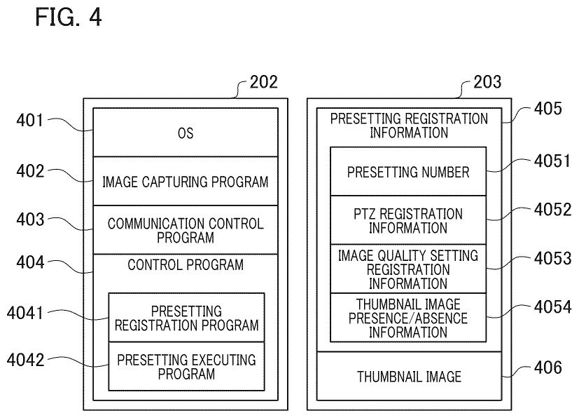

Next, various programs or various kinds of data stored in the primary storage device 202 and the secondary storage device 203 of the camera 102 will be described with reference to FIG. 4. FIG. 4 is a configuration diagram illustrating an example of a program of the imaging apparatus.

In the first embodiment, an OS 401, an image capturing program 402, a communication control program 403, and a control program 404 are loaded into the primary storage device 202. Presetting registration information 405 and a thumbnail image 406 are stored in the secondary storage device 203. The OS 401, the image capturing program 402, the communication control program 403, and the control program 404 that are loaded into the primary storage device 202 are also stored in the secondary storage device 203.

The OS 401 is a basic program that is provided to control the entire camera 102. Here, the OS 401 manages various programs such as the image capturing program 402, the communication control program 403, and the control program 404.

The OS 401 manages positions, addresses, sizes, and the like of various kinds of data such as the presetting registration information 405 and the thumbnail image 406, in the primary storage device 202 or the secondary storage device 203.

The image capturing program 402 acquires an image captured by the imaging unit 207 via the image input I/F 208 according to an image acquisition request from the client apparatus 103 or an instruction from another program. Then, the image capturing program 402 converts the acquired image into image data in a format of JPEG or video data in a format of H.264.

The communication control program 403 is a program that is provided to control communication with the client apparatus 103 from the network I/F 204 via the network 101. Examples of contents of communication include reception of an acquisition request for an image captured by the imaging unit 206 and reception a presetting registration information acquisition request or a thumbnail image acquisition request described below.

A request to be received from the client apparatus 103 may use, for example, a general communication protocol such as a hypertext transfer protocol (HTTP).

When a control command and the like are received from the client apparatus 103, the control program 404 controls the PTZ drive unit 205 or the camera control unit 206 based on the received command. In the first embodiment, a presetting registration program 4041 and a presetting execution program 4042 described below are also included.

Registration information 405 includes a presetting number 4051, PTZ registration information 4052, image quality setting registration information 4053, and thumbnail image presence/absence information 4054. The presetting number 4051 indicates a serial number of a presetting to be registered, and a plurality of presettings, for example, 100 presettings can be registered in the camera 102.

The PTZ registration information 4052 indicates a set value input to the PTZ drive unit 205. The image quality setting registration information 4053 indicates a set value input to the camera control unit 206. The thumbnail image presence/absence information 4054 indicates information regarding whether or not a thumbnail image corresponding to a presetting of the presetting number 4051 is stored. The thumbnail image 406 indicates a thumbnail image corresponding to the presetting number 4051.

Here, the presetting registration program 4041 stores an image captured by the imaging unit 207 as the thumbnail image 406 when designated presetting registration information is registered as the presetting registration information 405.

In this case, both the PTZ registration information 4052 and the image quality setting registration information 4053 do not need to be stored, and only one of the PTZ registration information 4052 and the image quality setting registration information 4053 may be stored. The thumbnail image 406 is not necessarily stored and may be stored as thumbnail image presence/absence information 4054.

Accordingly, in the registered presettings, at least one of the PTZ registration information 4052 and the image quality setting registration information 4053 is included, and cases where a thumbnail image is included and cases where a thumbnail image is not included are mixed.

The presetting execution program 4042 reads the PTZ registration information 4052 and the image quality setting registration information 4053 of the stored presetting registration information 405, and inputs the set values of the PTZ registration information 4052 and the image quality setting registration information 4053 to the PTZ drive unit 205 and the camera control unit 206, respectively. In this case, when the PTZ registration information 4052 or the image quality setting registration information 4053 is not stored, the presetting execution program 4042 omits the input of the set value of the PTZ registration information 4052 or the image quality setting registration information 4053.

Accordingly, if a presetting in which only the PTZ registration information 4052 is registered is executed, while an angle of view is switched to an angle of view of a thumbnail image, the tone or brightness of an image is not always as indicated by the thumbnail image.

On the other hand, when a presetting in which only the image quality setting registration information 4053 is registered is executed, while the tone or brightness of an image is the same as when a thumbnail image is acquired, an angle of view is not changed and is not always an angle of view as indicated by the thumbnail image.

Here, in comparison of the two cases, the angle of view has a higher degree of influence on an image to be acquired, and has greater deviation between an image associated with the thumbnail image and an image to be actually acquired. In other words, it can be said that a thumbnail image of a presetting in which the PTZ registration information 4052 is registered has information with a higher degree of accuracy for the user.

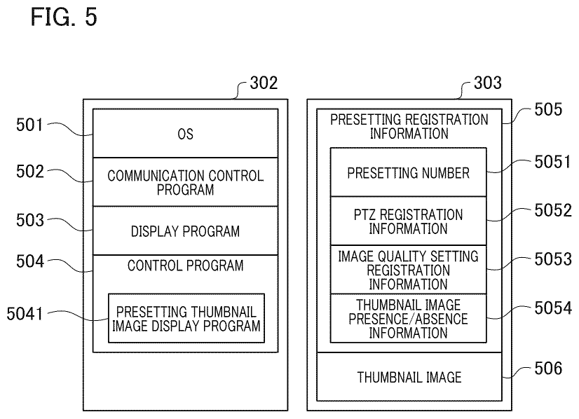

Next, various programs or various kinds of data stored in the primary storage device 302 and the secondary storage device 303 of the client apparatus 103 will be described with reference to FIG. 5. FIG. 5 is a configuration diagram illustrating an example of a program of the control device.

An OS 501, a communication control program 502, a display program 503, and a control program 504 are loaded into the primary storage device 302. Presetting registration information 505 and a thumbnail image 506 are stored in the secondary storage device 303.

The OS 501 is a basic program that controls the entire client apparatus 103. Here, the OS 501 manages positions (addresses) or sizes of various programs such as the OS 501, the communication control program 502, the display program 503, and the control program 504, in the primary storage device 302 or the secondary storage device 303.

The OS 501 manages positions (addresses) or sizes of various kinds of data such as the presetting registration information 505 and the thumbnail image 506, in the primary storage device 302 or the secondary storage device 303.

The communication control program 502 is a program that is provided to control communication with the camera 102 from the network I/F 305 via the network 101. Examples of contents of communication include transmission of an acquisition request for an image captured by the imaging unit 207 of the camera 102 and transmission of a presetting registration information acquisition request or a thumbnail image acquisition request described below.

A request to be transmitted to the camera 102 may use, for example, a general communication protocol such as a hypertext transfer protocol.

The display program 503 is a program that displays video data acquired from the camera 102, a thumbnail image of a presetting acquired from the camera 102, or the like on a display device, which is one of the user input/output I/F 304 in the client apparatus 103.

In the first embodiment, a GUI is displayed again in conjunction with execution of a thumbnail image acquisition program described below. An input using an external device such as a mouse or a keyboard, an input using a display device, which is a touch display, or the like can be received as an input from the user.

The control program 504 is a program that controls the camera 102 based on an input from the user input to the user input/output I/F 304 through the communication control program 502. In the first embodiment, a presetting thumbnail image display program 5041 described below is also included.

The presetting registration information 505 and the thumbnail image 506 are the same as the presetting registration information 405 and the thumbnail image 406 in FIG. 4.

Here, the presetting thumbnail image display program 5041 acquires the presetting registration information 505 and the thumbnail image 506 from the camera 102. Then, the presetting thumbnail image display program 5041 stores the presetting registration information 505 and the thumbnail image 506.

The presetting thumbnail image display program 5041 further displays the acquired thumbnail image 506 on the user input/output I/F 304 via the display program 503. With this, the user can visually recognizes the thumbnail image of the presetting via the user input/output I/F 304 to easily identify the presetting.

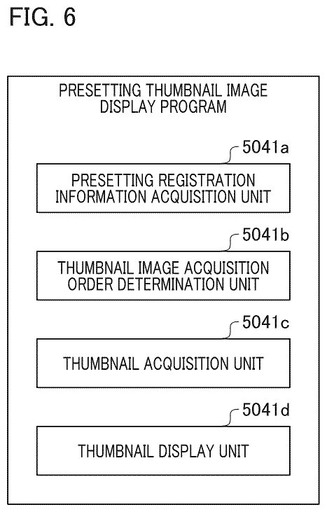

Next, the presetting thumbnail image display program 5041 will be described. FIG. 6 is a configuration diagram illustrating an example of a functional configuration of the presetting thumbnail image display program. As illustrated in FIG. 6, the presetting thumbnail image display program 5041 includes a presetting registration information acquisition unit 5041a, a thumbnail image acquisition order determination unit 5041b, a thumbnail acquisition unit 5041c, and a thumbnail display unit 5041d.

The presetting registration information acquisition unit 5041a acquires the presetting registration information 505, which is information registered in relation to presettings of the camera 102, from the camera 102.

The thumbnail image acquisition order determination unit 5041b determines an order of acquiring presetting thumbnail images, which are images corresponding to the presettings, in such a manner that the presetting thumbnail image for which a set value for changing an angle of view is included in the presetting registration information 505, among the presetting thumbnail images is acquired with priority.

Here, the presetting thumbnail image is an image captured by the camera 102 when the presetting is registered. That is, the presetting is executed, and an image of a region to be captured by the execution of the presetting is acquired as a presetting thumbnail image.

The presetting thumbnail image is not necessarily the image captured when the presetting is registered, and may be at least an image corresponding to the presetting. For example, the presetting thumbnail image may be a map image or an icon image indicating a position to be captured with the presetting.

The thumbnail acquisition unit 5041c acquires the presetting thumbnail images according to the order determined by the thumbnail image acquisition order determination unit 5041b. The thumbnail display unit 5041d displays the presetting thumbnail images.

The thumbnail image acquisition order determination unit 5041b may determine the order in such a manner that all presetting thumbnail images for which a set value for changing an angle of view and a set value for changing image quality are included in the presetting registration information 505 are acquired first.

In this case, the thumbnail image acquisition order determination unit 5041b may determine the order in such a manner that all presetting thumbnail images for which only a set value for changing an angle of view is included in the presetting registration information 505 is acquired second.

In this case, the thumbnail image acquisition order determination unit 5041b may determine the order in such a manner that all presetting thumbnail images for which only a set value for changing image quality is included in the presetting registration information 505 is acquired third.

In this case, the thumbnail display unit 5041d may have a page switching function of collectively displaying a plurality of presetting thumbnail images and displaying presetting thumbnail images not displayed at a time through page switching.

In this case, the thumbnail image acquisition order determination unit 5041b may determine the order in such a manner that all presetting thumbnail images displayed on the thumbnail display unit are acquired first.

In this case, the thumbnail image acquisition order determination unit 5041b may determine the order in such a manner that all presetting thumbnail images which are not displayed on the thumbnail display unit and for which a set value for changing an angle of view is included in the presetting registration information 505 are acquired second.

In this case, the thumbnail image acquisition order determination unit 5041b may determine the order in such a manner that all presetting thumbnail images which are not displayed on the thumbnail display unit and for which a set value for changing an angle of view is not included in the presetting registration information 505 are acquired third.

The thumbnail image acquisition order determination unit 5041b may determine the order in such a manner that a presetting thumbnail image which is displayed on the thumbnail display unit and for which a set value for changing an angle of view is included in the presetting registration information 505 is acquired with priority.

Hereinafter, an example of processing that is executed by the presetting thumbnail image display program 5041 will be described.

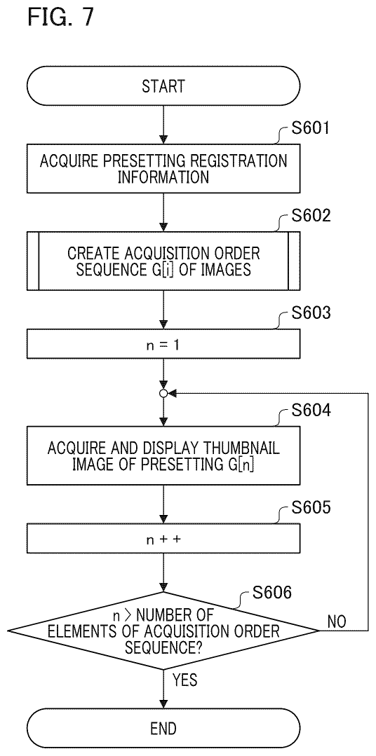

FIG. 7 is a flowchart illustrating an example of processing in the first embodiment. Specifically, FIG. 7 is a flowchart of the presetting thumbnail image display program 5041.

In Step S601, the CPU 301 acquires the presetting registration information 405 from the camera 102.

In Step S602, the CPU 301 creates an acquisition order sequence of thumbnail images using the acquired presetting registration information 505.

In Step S603, the CPU 301 substitutes 1 for a variable n.

In Step S604, the CPU 301 acquires a thumbnail image corresponding to a presetting with an n-th presetting number of the acquisition order sequence created in Step S602 and displays the thumbnail image on the user input/output I/F 304 after the acquisition is completed.

In Step S605, the CPU 301 substitutes a value obtained by adding 1 to the variable n in the variable n.

In Step S606, the CPU 301 determines whether or not n is greater than the number of elements of the acquisition order sequence. If determination is made that n is greater than the number of elements of the acquisition order sequence, the CPU 301 ends the process. On the other end, if determination is made that n is equal to or less than the number of elements of the acquisition order sequence, the CPU 301 returns the process to Step S604.

With the execution of the processing illustrated in FIG. 7, the thumbnail images are displayed in an order of the acquisition order determined in Step S602, and the user can view the thumbnail images without waiting for acquisition of all thumbnail images.

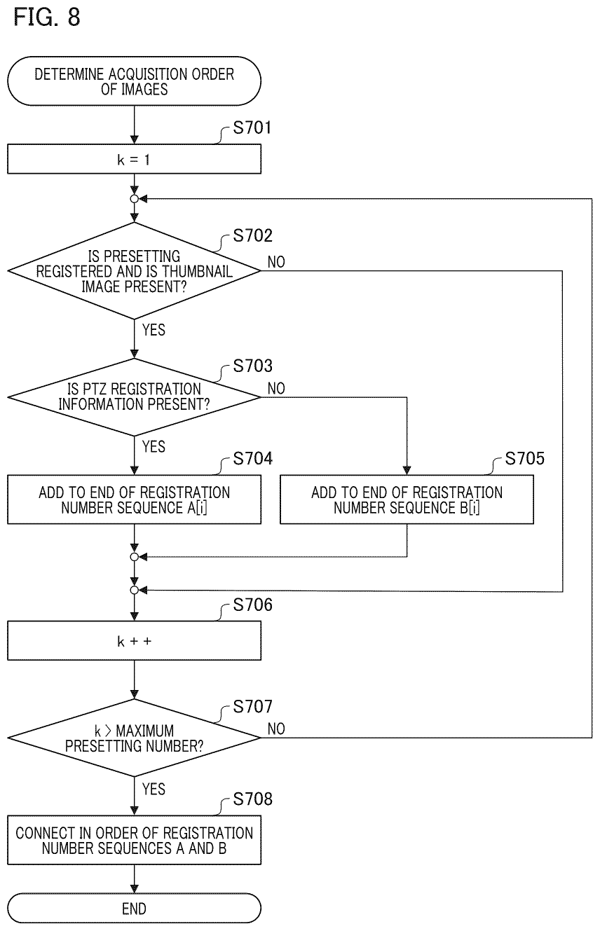

Next, details of Step S602 illustrated in FIG. 7 will be described with reference to FIG. 8. FIG. 8 is a flowchart illustrating an example of processing details in the first embodiment.

In Step S701, the CPU 301 substitutes 1 in a variable k.

In Step S702, the CPU 301 determines whether or not a presetting with a presetting number k is registered and a thumbnail image is stored in the camera 102, from the presetting number 4051 and the thumbnail image presence/absence information 4054.

Then, if determination is made that the presetting with the presetting number k is registered and the thumbnail image is stored in the camera 102, the CPU 301 makes the process proceed to Step S703.

On the other hand, if determination is made that the presetting with the presetting number k is not registered or if determination is made that a thumbnail image is not stored in the camera 102, the CPU 301 makes the process proceed to Step S707.

In Step S703, the CPU 301 determines whether or not PTZ registration information is stored in the presetting with the presetting number k, based on the PTZ registration information 5052. If determination is made that PTZ registration information is stored in the presetting with the presetting number k, the CPU 301 makes the process proceed to Step S704.

On the other hand, if determination is made that PTZ registration information is not stored in the presetting with the presetting number k, the CPU 301 makes the process proceed to Step S705.

In Step S704, the CPU 301 adds k to an end of a registration number sequence A.

In Step S705, the CPU 301 adds k to an end of a registration number sequence B.

In Step S706, the CPU 301 substitutes a value obtained by adding 1 to the variable k in the variable k.

In Step S707, the CPU 301 determines whether or not k is greater than a maximum presetting number that can be registered in the camera 102. If determination is made that k is greater than the maximum presetting number that can be registered in the camera 102, the CPU 301 makes the process proceed to Step S709.

On the other hand, if determination is made that k is equal to or less than the maximum presetting number that can be registered in the camera 102, the CPU 301 returns the process to Step S702.

In Step S708, the CPU 301 connects the registration number sequence A and the registration number sequence B in an order of the registration number sequence A and the registration number sequence B.

With the execution of the processing illustrated in FIG. 8, the thumbnail images can be acquired in order from the thumbnail image corresponding to the presetting for which the PTZ registration information 5052 is stored in the presetting registration information 505. With this, the thumbnail images are displayed on the user input/output I/F 304 from the thumbnail image having a higher degree of accuracy and importance for the user.

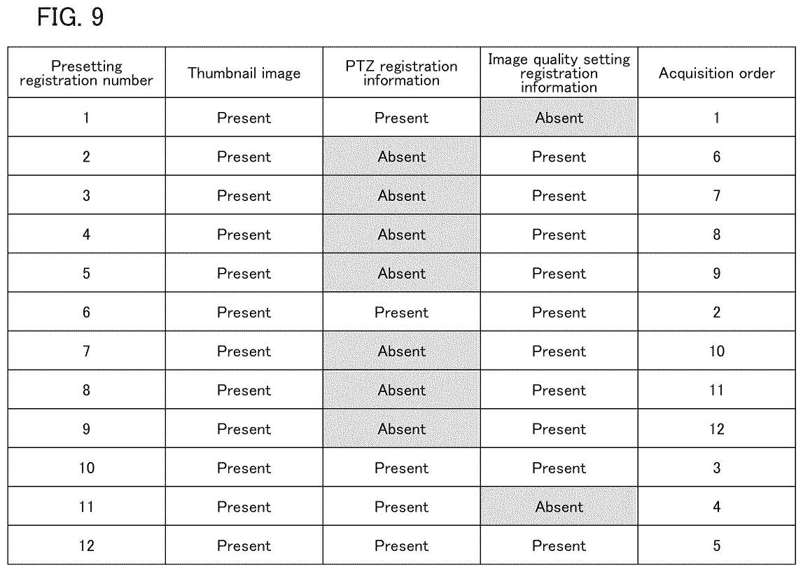

Next, exchange between the camera 102 and the client apparatus 103 when thumbnail images corresponding to presettings are actually acquired and displayed, and an example of a GUI displayed on a display unit of the user input/output I/F 304 in the first embodiment will be described with reference to FIGS. 9, 10, and 11A to 11C.

FIG. 9 is a diagram illustrating an example of the presetting registration information in the first embodiment. FIG. 9 is a table illustrating an example of presettings registered in the camera 102. In respective rows in the table, a presetting registration number, thumbnail image presence/absence information, and the presence/absence of PTZ registration information and image quality setting registration information are described. In the last row, an acquisition order when the processing is executed according to the flow of FIG. 8 is described.

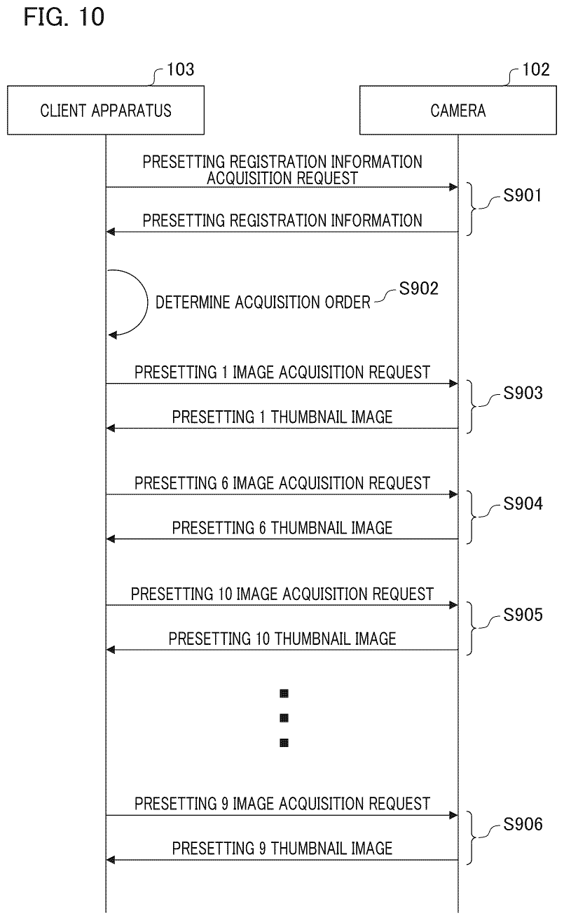

FIG. 10 is a diagram illustrating an example of a sequence diagram between the imaging apparatus and the control device in the first embodiment. FIG. 10 is a sequence diagram between the camera 102 and the client apparatus 103 when the presettings described in FIG. 9 are registered in the camera 102.

In Step S901, the client apparatus 103 transmits a presetting registration information acquisition request to the camera 102, and the camera 102 returns the presetting registration information in response to the presetting registration information acquisition request.

In Step S902, the client apparatus 103 determines the acquisition order of the thumbnail images according to the flow described in FIG. 8. In the first embodiment, since the sequence when the presettings described in FIG. 9 are registered in the camera 102 is illustrated, the acquisition order is the acquisition order described in FIG. 9.

In Step S903, the client apparatus 103 transmits an acquisition request for a thumbnail image of a presetting number 1 to the camera 102 according to the determined acquisition order. Then, in Step S903, the camera 102 returns thumbnail image data of the presetting number 1.

Also in Steps S904 and S905, the client apparatus 103 transmits acquisition requests for thumbnail images of presetting numbers 6 and 10 to the camera 102 according to the determined acquisition order. Then, also in Steps S904 and S905, the camera 102 returns thumbnail image data of the presetting numbers 6 and 10.

Then, similar processing is repeatedly executed, and finally, in Step S906, the client apparatus 103 acquires a thumbnail image of a presetting number 9 that is the end of the acquisition order, from the camera 102.

In the first embodiment, while the sequence that the thumbnail images are acquired one by one is illustrated, there is no problem even with a sequence that an acquisition order is designated and thumbnail images are acquired at once.

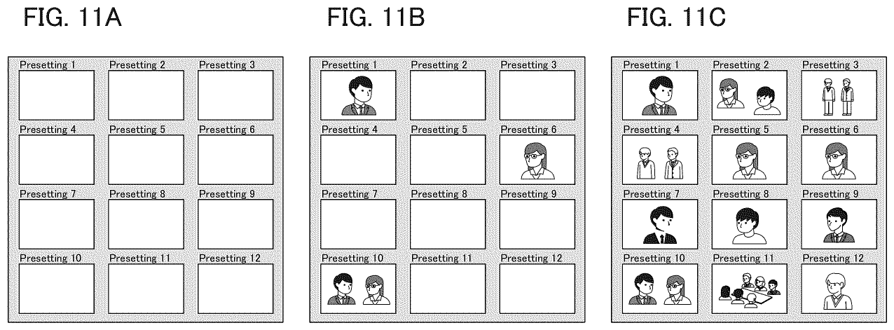

FIGS. 11A to 11C are diagrams illustrating an example of a display unit of the control device in the first embodiment. FIGS. 11A to 11C are an example of a GUI that is displayed on the user input/output I/F 304 when the presettings described in FIG. 8 are registered in the camera 102.

The client apparatus 103 displays the thumbnail images corresponding to the presettings on the user input/output I/F 304 in a list, so that the user can easily identify the presettings.

FIG. 11A illustrates an example of a GUI before processing of acquiring thumbnail images starts. FIG. 11B illustrates an example of a GUI at a moment at which the processing to Step S905 in the processing illustrated in FIG. 9 is completed.

FIG. 11C illustrates an example of a GUI at a moment at which the processing to Step S906 in the processing illustrated in FIG. 9 is completed. The GUI is updated each time the client apparatus 103 acquires a thumbnail image, and displays only acquired thumbnail images as in FIG. 11B until all thumbnail images are acquired. Then, a display order is determined according to the processing illustrated in FIG. 8. For this reason, the user can visually recognize the thumbnail images from the thumbnail image having a higher degree of accuracy and importance for the user himself or herself as a result.

### Second Embodiment

In the first embodiment, since the thumbnail image corresponding to the presetting for which the PTZ registration information is registered has importance for the user, the unit configured to acquire the thumbnail image of the corresponding presetting with priority has been described.

In the second embodiment, important presettings among the presettings for which the PTZ registration information is registered are further extracted. Hereinafter, different portions from the first embodiment will be primarily described. The same or equivalent components and processing as those in the first embodiment are represented by the same reference numerals, and redundant description will not omitted.

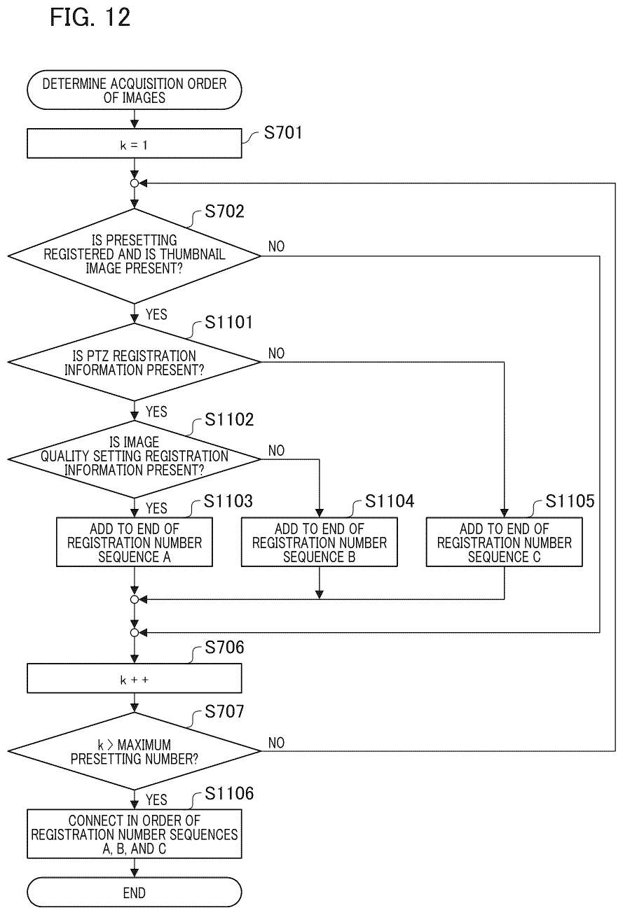

FIG. 12 is a flowchart illustrating an example of processing in the second embodiment. FIG. 12 is a detailed flowchart in the present embodiment of Step S602 of FIG. 7. Steps S701, S702, S707, and S708 illustrated in FIG. 12 are similar to those in the first embodiment.

In Step S1101, the CPU 301 determines whether or not PTZ registration information is stored in the presetting with the presetting number k, based on the PTZ registration information 5052. If determination is made that PTZ registration information is stored, the CPU 301 makes the process proceed to Step S1102. On the other hand, if determination is made that PTZ registration information is not stored, the CPU 301 makes the process proceed to Step S1105.

In Step S1102, the CPU 301 determines whether or not image quality setting registration information is stored in the presetting with the presetting number k, based on the image quality setting registration information 5053. If determination is made that image quality setting registration information is stored, the CPU 301 makes the process proceed to Step S1103. On the other hand, if determination is made that image quality setting registration information is not stored, the CPU 301 makes the process proceed to Step S1104.

In Step S1103, the CPU 301 adds k to an end of a registration number sequence A.

In Step S1104, the CPU 301 adds k to an end of a registration number sequence B.

In Step S1105, the CPU 301 adds k to the end of a registration number sequence C.

In Step S1106, the CPU 301 connects the registration number sequence A, the registration number sequence B, and the registration number sequence C in an order of A, B, and C.

With the execution of the processing illustrated in FIG. 12, initially, a thumbnail image for which both the PTZ registration information 5052 and the image quality setting registration information 5053 are stored in the presetting registration information 505 is acquired. Next, a thumbnail image for which only the PTZ registration information 5052 is stored is acquired. Finally, a thumbnail image for which only image quality setting registration information 5053 is stored is acquired.

With this, the thumbnail images are displayed on the user input/output I/F 304 from a thumbnail image that has small deviation between an acquired image associated with the thumbnail image and an image to be actually acquired, and has a higher degree of accuracy and importance for the user.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the control device or the like through a network or various storage media. Then, a computer (or a CPU, an MPU, or the like) of the control device or the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2023-140389, filed on Aug. 30, 2023, which is hereby incorporated by reference herein in its entirety.

What is claimed is:

1. A control device comprising:
at least one processor or circuit configured to function as:
a thumbnail image acquisition order determination unit configured to determine an order of acquiring thumbnail images, which are images corresponding to presetting information including one or a plurality of set values regarding a camera, in such a manner that a thumbnail image corresponding to a presetting for which at least a set value for changing an angle of view of the camera is included, among the thumbnail images is acquired with priority;
a thumbnail acquisition unit configured to acquire the thumbnail images according to the order determined by the thumbnail image acquisition order determination unit; and
a thumbnail display control unit configured to display the thumbnail images on a display unit.

2. The control device according to claim 1,
wherein the thumbnail image acquisition order determination unit is configured to determines the order in such a manner that a thumbnail image corresponding to a presetting for which a set value for changing the angle of view and a set value for changing image quality of an image or a video to be captured by the camera are included is acquired, a thumbnail image corresponding to a presetting for which a set value for changing the angle of view is included and a set value for changing the image quality is not included is next acquired, and a thumbnail image corresponding to a presetting for which a set value for changing the image quality is included and a set value for changing the angle of view is not included is then acquired.

3. The control device according to claim 1,
wherein the thumbnail display control unit has a page switching function of displaying a plurality of the thumbnail images on the display unit and displaying a part of the thumbnail images through page switching, and
the thumbnail image acquisition order determination unit is configured to determine the order in such a manner the thumbnail images which are displayed on the thumbnail display unit without performing the page switching by the thumbnail display control unit are acquired, the thumbnail image that are not displayed on the display unit by the thumbnail display control unit and correspond to presettings for which at least a set value for changing the angle of view is included are next acquired, and the thumbnail images that are not displayed on the display unit by the thumbnail display control unit and correspond to presettings for which a set value for changing the angle of view is not included are then acquired.

4. The control device according to claim 3,
wherein the thumbnail image acquisition order determination unit is configured to determine the order in such a manner that the thumbnail images that are displayed on the display unit by the thumbnail display control unit and correspond to presettings for which at least a set value for changing the angle of view is included are acquired with priority.

5. A control method comprising:
determining an order of acquiring thumbnail images, which are images corresponding to presettings including one or a plurality of set values regarding a camera, in such a manner that a thumbnail image corresponding to a presetting for which at least a set value for changing an angle of view of the camera is included, among the thumbnail images is acquired with priority;
acquiring the thumbnail images according to the determined order; and
displaying the thumbnail images on a display unit.

6. A non-transitory computer-readable storage medium configured to store a computer program comprising instructions for executing following processes:
determining an order of acquiring thumbnail images, which are images corresponding to presettings including one or a plurality of set values regarding a camera, in such a manner that a thumbnail image corresponding to a presetting for which at least a set value for changing an angle of view of the camera is included, among the thumbnail images is acquired with priority;
acquiring the thumbnail images according to the determined order; and
displaying the thumbnail images on a display unit.
